(19) United States
(12) Patent Application Publication
(10) Pub. No.: US 2024/0428044 A1
(43) Pub. Date: Dec. 26, 2024

(54) SYSTEMS AND METHODS FOR RETRIEVAL BASED QUESTION ANSWERING USING NEURA NETWORK MODELS

(71) Applicant: Salesforce, Inc., San Francisco, CA (US)

(72) Inventors: Ye Liu, Palo Alto, CA (US); Semih Yavuz, Palo Alto, CA (US); Meghana Moorthy Bhat, Palo Alto, CA (US); Rui Meng, Palo Alto, CA (US); Shafiq Joty, Palo Alto, CA (US); Caiming Xiong, Palo Alto, CA (US); Yingbo Zhou, Palo Alto, CA (US)

(21) Appl. No.: 18/497,395

(22) Filed: Oct. 30, 2023

Related U.S. Application Data
(60) Provisional application No. 63/510,074, filed on Jun. 23, 2023.

(51) Int. Cl. G06N 3/006; G06N 3/0455

(52) U.S. Cl. CPC G06N 3/006; G06N 3/0455

(57) ABSTRACT

Embodiments described herein provide a framework that integrates a retriever model and the LLM to feed retrieved passages to an LLM to generate an answer conditioned on the retrieved passages in response to a query. For example, in one embodiment, a single-round approach is implemented, which involves directly transmitting the retrieved passages to the LLM. For another example, a multi-round methodology is implemented, which involves initially presenting the retrieved passages to the Language Model, collecting its responses, and then adjusting our interaction with the Language Model based on this acquired feedback.

### CROSS REFERENCE(S)

This instant application is a nonprovisional of and claims priority under 35 U.S.C. 119 to U.S. Provisional application No. 63/510,074, filed Jun. 23, 2023, which is hereby expressly incorporated by reference herein in its entirety.

### TECHNICAL FIELD

The embodiments relate generally to natural language processing and machine learning systems, and more specifically to systems and method for integrating retriever models and large language models (LLMs) for answer generation.

### BACKGROUND

Large Language Models (LLMs) have been used in various complex natural language processing (NLP) tasks in a variety of applications, such as question answering in a chatbot application, and/or the like. LLMs, however, may struggle with limited knowledge representation subject to their respective training data, resulting in inaccuracies and insufficient specificity in open-domain question answering. For example, for applications in Information Technology (IT) trouble shoot, customer service, and/or the like, LLMs sometimes may not be able to generate satisfactory answers to a user question in the specific domain.

### BRIEF DESCRIPTION OF THE DRAWINGS

FIG. 1A is a simplified diagram illustrating a generative question-answering framework using a concatenation of top-k retrieved source documents as context, according to one embodiment described herein.

FIG. 1B is a simplified diagram illustrating a generative question-answering framework that generates independent answers using each retrieved source document as context to select a most accurate final answer, according to one embodiment described herein.

FIG. 1C is a simplified diagram illustrating a generative question-answering framework that uses a prompt to guide the generation of an answer based on a question and one or more documents as context, according to one embodiment described herein.

FIGS. 2A-2C are simplified diagrams illustrating various example prompts used in the generation framework in FIGS. 1A-1C, according to one embodiment described herein.

FIG. 3 is a simplified diagram illustrating a two-stage generative question-answering framework, according to one embodiment described herein.

FIG. 4 is a simplified diagram illustrating an alternative embodiment of a two-stage generative question-answering framework, according to one embodiment described herein.

FIG. 5 is a simplified diagram illustrating a computing device implementing the answer generation integrating retrievers and LLMs, according to one embodiment described herein.

FIG. 6 is a simplified diagram illustrating the neural network structure implementing the answer generation module described in FIG. 5, according to some embodiments.

FIG. 7 is a simplified block diagram of a networked system suitable for implementing the answer generation framework described in FIG. 5 and other embodiments described herein.

FIG. 8 is an example logic flow diagram illustrating a method of generating an answer to an input question using one or more neural network models based on the framework shown in FIGS. 1-7, according to some embodiments described herein.

FIG. 9 is an example logic flow diagram illustrating a method of generating an answer to an input question using one or more neural network models based on the framework shown in FIGS. 1-7, according to some embodiments described herein.

FIGS. 10-11 provide example results of data experiments comparing generation frameworks described in FIGS. 1A-1C and FIGS. 3-4 with various baselines, according to some embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

Retrieval-based document search and LLMs may be combined to perform question answering tasks. For example, in response to a user utterance “I cannot login to my shopping account,” the chatbot may first retrieve relevant support documents, e.g., “account login issues,” and then generate an answer based on the retrieved support document. But existing systems often lack efficient use of retrieved source documents to generate an accurate answer.

Embodiments described herein provide a retrieval-based question-answering framework that generates a plurality of answers to an input question based on a plurality of retrieved supporting documents in parallel, and selects one or more relevant answers as a final response. For example, a retriever model may select top-K relevant passages in response to an input question. An LLM may then generate a respective answer using each selected passage, respectively, to form an answer pool. A language model may then rate and/or rank the answers in the pool to generate the final response to the input question.

In one embodiment, a retriever model may perform retrieval-based document search on a pool of source documents to retrieve multiple source documents, e.g., top-K source documents. Such retriever is combined with LLMs to perform question answering tasks.

In one embodiment, the retriever model may access and send retrieved source documents to one or more LLMs that are hosted on external servers via one or more application programming interfaces (APIs). The LLMs may in turn transmit back generated answers via the APIs.

In one embodiment, the combined retriever and LLM framework may take a single-round approach, which involves directly transmitting the retrieved source documents to the LLM. The LLM may then return an answer using the retrieved source documents as context.

In one embodiment, the combined retriever and LLM framework may take a multi-round approach: the retrieved source documents may be initially presented to the LLM, which may generate one or more answers based on each of the retrieved source document; the generated one or more answers may then be adjusted based on acquired feedback on the answers.

In this way, a chatbot application may generates an answer to an input question with specificity to source documents, which enhances accuracy in providing support and service, e.g., in IT trouble shooting. Therefore, AI assistance technology is improved.

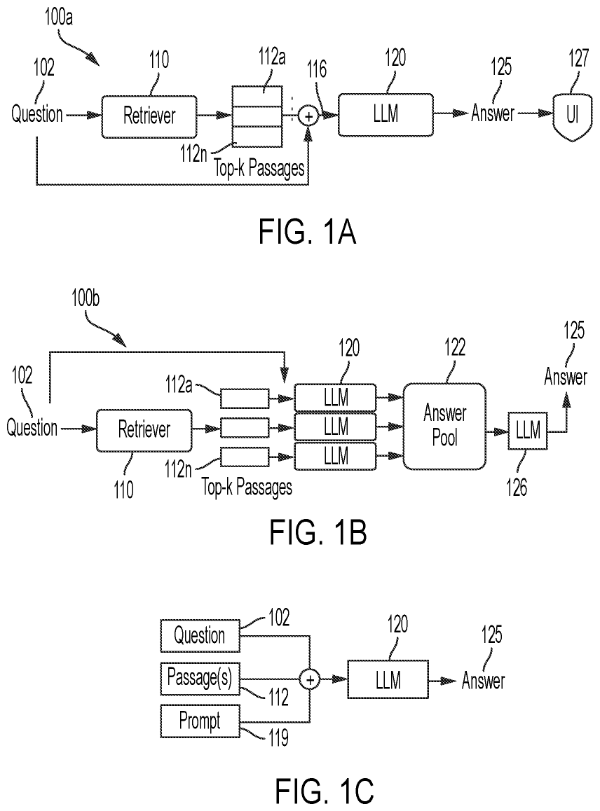

FIG. 1A is a simplified diagram illustrating a generative question-answering framework 100a using a concatenation of top-k retrieved source documents as context, according to one embodiment described herein. The generative question-answering framework 100a comprises a neural network based retriever model 110 and at least one LLM 120.

In one implementation, the retriever model 110 may be trained, using a dataset of question-passage pairs to retrieve the most relevant context for question answering. For example, the retriever model 110 may select one or more related source documents 112a-n from a database of source documents given an input question 102. The retriever model 110 may predict a score for each available source document, and select multiple, e.g., top-K source documents. The number k of top documents may vary based on the desired input length M of the LLM 120, e.g., k can be set to 5, 10, or 20, such that the total length of k passages, each having a maximum length of L, remains within the maximum input length M of the LLM 120 (i.e., KL<M).

In one embodiment, the top k passages 112a-112n are concatenated in the ranking order generated by the retriever model 110 and also with the input question 102 into a single text string 116 to form an input to LLM 120. By incorporating these supplementary passages 112a-n as context, the LLM 120 is provided with a comprehensive and informative context, which may potentially enhance the accuracy of the output answer 125. The final answer 125 may be represented as:

a=LLM(q,p₁,p₂, . . . pₖ)

where q denotes input question 102, and p₁,p₂, . . . pₖ denote the top k passages 112a-n. The generated output answer may thus be presented via a chatbot application user interface 127.

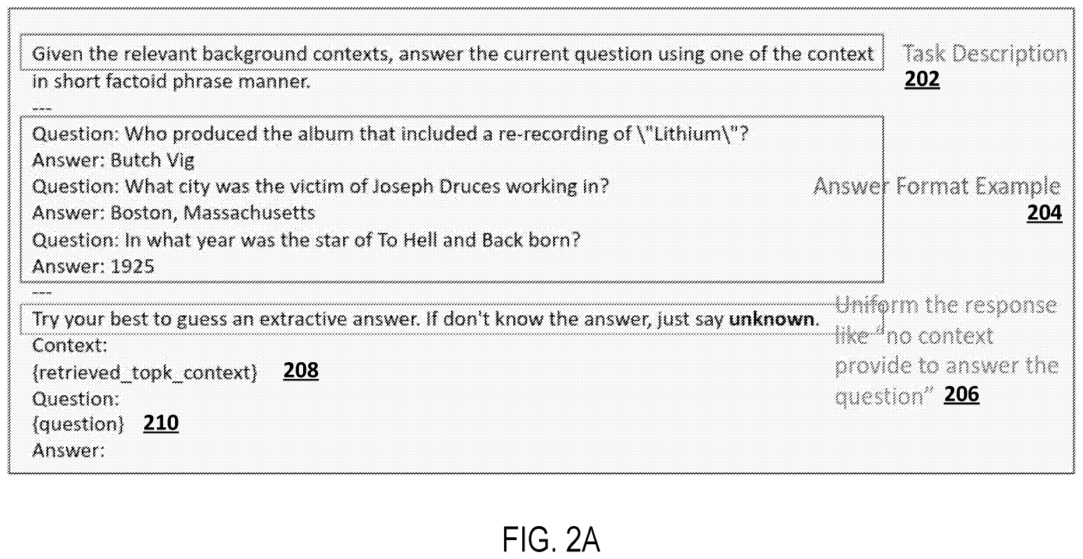

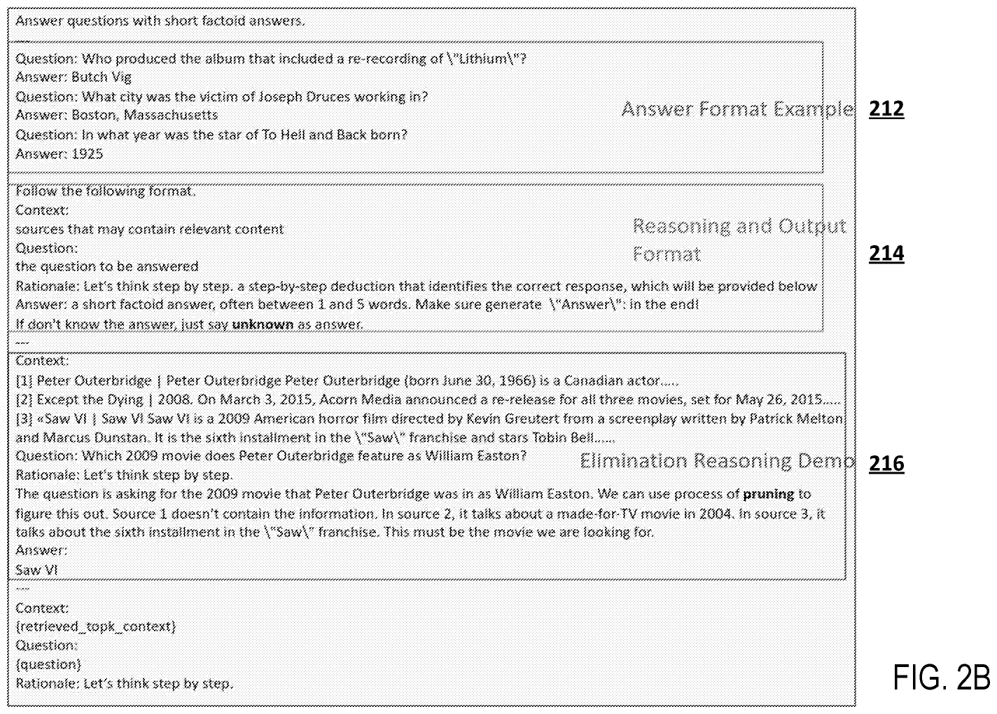

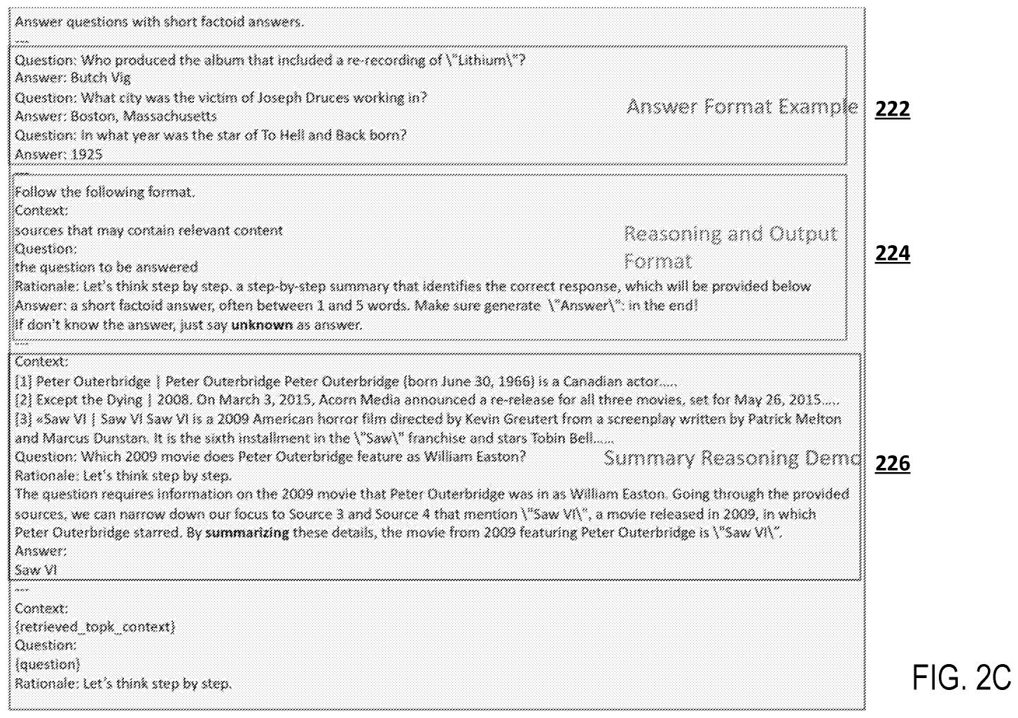

When LLM 120 is fed with the concatenated top k passages as context, as the effectiveness of LLM 120 largely relies on its training performance and training data relevance. It is possible that in some scenarios, LLM 120 may not provide an answer directly to question 102, or LLM 120 may discern that the retrieved context is insufficient for a response. In such cases, the LLM 120 might produce outputs like “the provided input does not contain the context to answer the question.” For example, a prompt (e.g., 200a in FIG. 2A) may include an instruction, e.g., “If don't know the answer, just say Unknown,” for LLM 120 to generate an answer of “unknown” when LLM 120 believes the given context 112a-n is inadequate for an answer.

Using the concatenated passages 112a-n as context for LLM 120, it may happen that an answer of “unknown” is generated even when one of the retrieved passages contains the ideal context necessary to answer the question. This is because the LLM 120 may possibly become confused due to the complexity or abundance of input 116, e.g., when the size of concatenated of top k passages is significant.

FIG. 1B is a simplified diagram illustrating a generative question-answering framework 100b that generates independent answers using each retrieved source document as context to select a most accurate final answer, according to one embodiment described herein. As shown in diagram 100b, after the retriever model 110 retrieves top-k source documents 112a-n, each source document 112a-n is independently fed, together with the input question 102, to the LLM 120, to each generate a candidate answer. The generated answers form an answer pool 122.

In one embodiment, a majority voting mechanism may be then applied to this answer pool 122 to determine the final answer 125, which can be denoted by the following equation:

$${a}_{1} = LLM ( q , {p}_{1} ) , … , {a}_{k} = LLM ( q , {p}_{k} ) , majority = arg {max}_{i} {a}_{i} .$$

In one embodiment, for example, the majority voting mechanism may include a human evaluator to review and select the best answer. For another example, the majority voting mechanism may include an LLM 126 that selects the best answer 125 in response to the question 102.

FIG. 1C is a simplified diagram illustrating a generative question-answering framework that uses a prompt to guide the generation of an answer based on a question and one or more documents as context, according to one embodiment described herein. In one embodiment, for either the framework 100a in FIG. 1A or 100b in FIG. 1B, LLM 120 may be provided a prompt 119 that is combined with question 102 and one or more retrieved passages 112 as an input to generate an answer 125. For example, the prompt 119 may serve as a template that provides instructions for the LLM 120 to generate an answer 125 using the passages(s) 112 as context information to the question 102. Example prompts can be found in FIGS. 2A-2C.

FIGS. 2A-2C are simplified diagrams illustrating various example prompts used in the generation framework in FIGS. 1A-1C, according to one embodiment described herein. FIG. 2A shows an example zero-shot prompt, providing only a task definition 202 and desired output format 204, without any demo example. The prompt may further include an instruction 206 to uniform the response like “no context provide to answer the question.”

For example, the retrieved source documents (concatenated if more than one) 112a-n in FIG. 1A may be populated into field 208, and the question 102 may be populated into field 210. Thus the prompt template incorporated with retrieved source documents and question 102 may be fed to LLM 120. For 100b in FIG. 1B, field 208 only incorporates a single retrieved passage, and different prompts may be fed to LLM 120 independently to generate answers.

Prompt examples shown in FIGS. 2B-2C each uses demonstrative examples to guide answer generation. In FIG. 2B, the prompt includes an answer format example 212, a reasoning and output format 214, and a demonstrative example 216 that shows the reasoning is to prune irrelevant passages and using the few remaining relevant ones for answer generation. Specifically, this prompt may instruct LLM 120 to effectively identify answerable passages through a process of selective elimination. As a result, the demonstration 216 involves differentiating irrelevant passages from the ones that can provide an answer, and subsequently generating the final response based on the few relevant passages.

As shown in FIG. 2C, the prompt includes an answer format example 222, a reasoning and output format 224, and a demonstrative example 226 that initially identifies the relevant information and then summarize the relevant information like chain of thought and generate the final answer. Specifically, the prompt instructs LLM 120 to generate a summary that extracts the central information from the Top-k passages. Based on this synthesized summary, the LLM 120 may produce the final answer. Therefore, the demonstrative example 226 exhibits how the model selects useful information from the passage before delivering the final response.

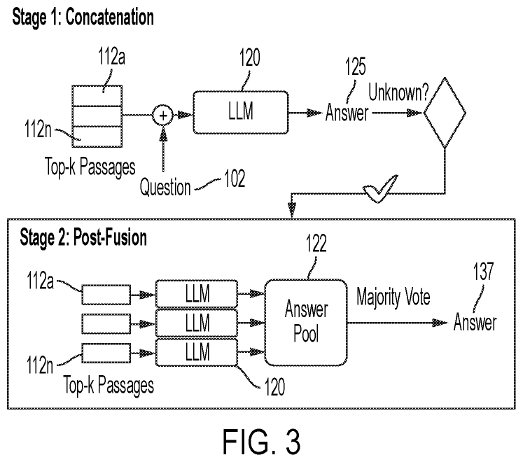

FIG. 3 is a simplified diagram illustrating a two-stage generative question-answering framework, according to one embodiment described herein. For example, based on the initial feedback received either “unknown” or a list of candidate answers, the interaction process with the LLM 120 may be adjusted accordingly. As shown in FIG. 3, at stage 1, the concatenation method as illustrated in framework 100a in FIG. 1A may be employed to obtain an answer 125 predicted by the LLM 129 based on concatenated passages 112a-n and question 102. If the LLM 120 determines that the input passages 112a-n are unable to provide an answer to the question 102 (i.e., “unknown” responses), the process then proceeds to stage 2 where the method employed by framework 100b in FIG. 2B to produce an answer pool 122 by independently generating an answer for each passage 112a-n. Finally, a majority vote (e.g., an LLM prediction, and/or with human feedback, etc.) may select the final answer 137 from the answer pool 122.

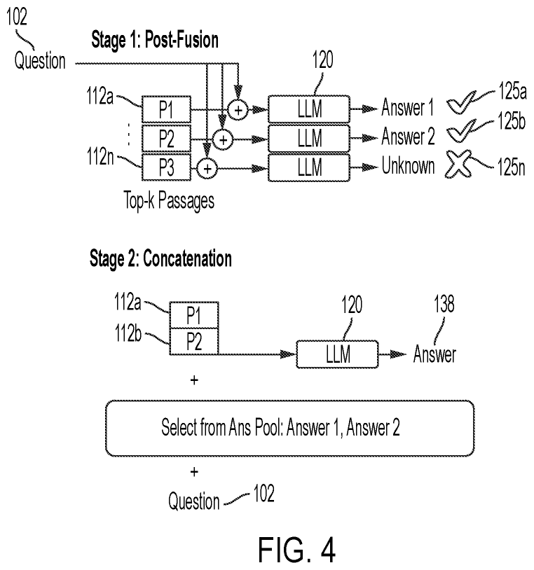

FIG. 4 is a simplified diagram illustrating an alternative embodiment of a two-stage generative question-answering framework, according to one embodiment described herein. As shown in FIG. 4, at stage 1, framework 100b in FIG. 1B may be implemented to curate a pool of potential answers based on each passage 112a-n and question 102. Upon evaluating each answer 125a-n in the answer pool, a passage selection process is adopted to discard passages that yield an “unknown” output (e.g., 125n) by the LLM 120. Thus, at stage 2, the remaining passages corresponding to answers that are not “unknown” (e.g., 112a-b corresponding to answers 125a-b) may be concatenated with the answers 125a-b into an input string and fed to the LLM 120. In this way, the LLM 120 may generate the final answer 138. The LLM 120 may be guided in effectively extracting (distilling) the correct answer from the pool of candidates.

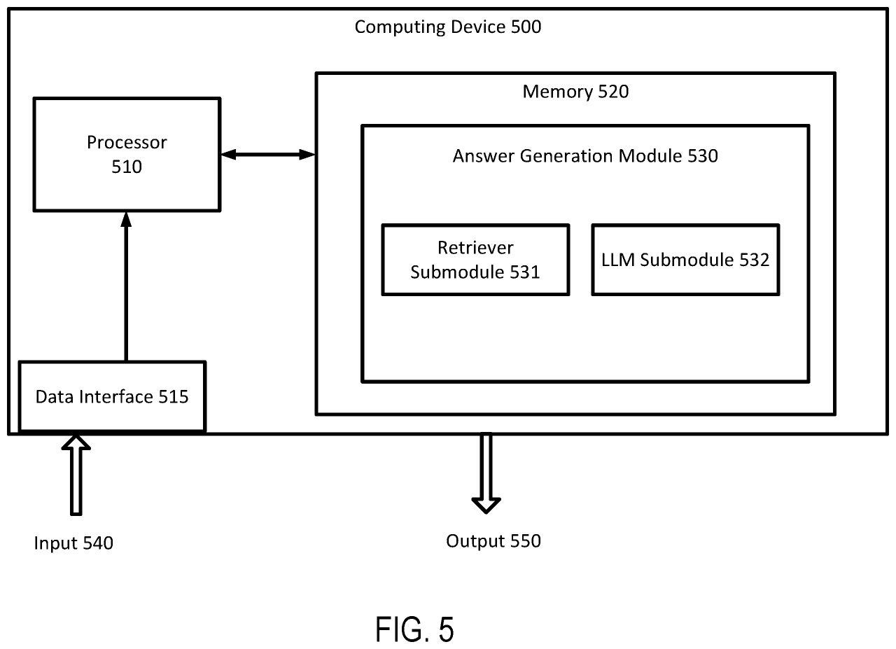

FIG. 5 is a simplified diagram illustrating a computing device implementing the answer generation integrating retrievers and LLMs, according to one embodiment described herein. As shown in FIG. 5, computing device 500 includes a processor 510 coupled to memory 520. Operation of computing device 500 is controlled by processor 510. And although computing device 500 is shown with only one processor 510, it is understood that processor 510 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 500. Computing device 500 may be implemented as a stand-alone subsystem, as a board added to a computing device, and/or as a virtual machine.

Memory 520 may be used to store software executed by computing device 500 and/or one or more data structures used during operation of computing device 500. Memory 520 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 510 and/or memory 520 may be arranged in any suitable physical arrangement. In some embodiments, processor 510 and/or memory 520 may be implemented on a same board, in a same package (e.g., system-in-package), on a same chip (e.g., system-on-chip), and/or the like. In some embodiments, processor 510 and/or memory 520 may include distributed, virtualized, and/or containerized computing resources. Consistent with such embodiments, processor 510 and/or memory 520 may be located in one or more data centers and/or cloud computing facilities.

In some examples, memory 520 may include non-transitory, tangible, machine readable media that includes executable code that when run by one or more processors (e.g., processor 510) may cause the one or more processors to perform the methods described in further detail herein. For example, as shown, memory 520 includes instructions for answer generation module 530 that may be used to implement and/or emulate the systems and models, and/or to implement any of the methods described further herein, answer generation module 530 may receive input 540 such as an input training data (e.g., question and answer pairs) via the data interface 515 and generate an output 550 which may be an answer to a question.

The data interface 515 may comprise a communication interface, a user interface (such as a voice input interface, a graphical user interface, and/or the like). For example, the computing device 500 may receive the input 540 (such as a training dataset) from a networked database via a communication interface. Or the computing device 500 may receive the input 540, such as a training data sample, from a user via the user interface.

In some embodiments, the answer generation module 530 is configured to generate an answer in response to a question as described herein and in Appendix I. The answer generation module 530 may further include a retriever submodule 531 and an LLM submodule 532.

In one implementation, the LLM submodule 532 may be located external to computing device 500. The computing device 500 may communicate with the external LLM submodule 532 via an LLM API.

Some examples of computing devices, such as computing device 500 may include non-transitory, tangible, machine readable media that include executable code that when run by one or more processors (e.g., processor 510) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

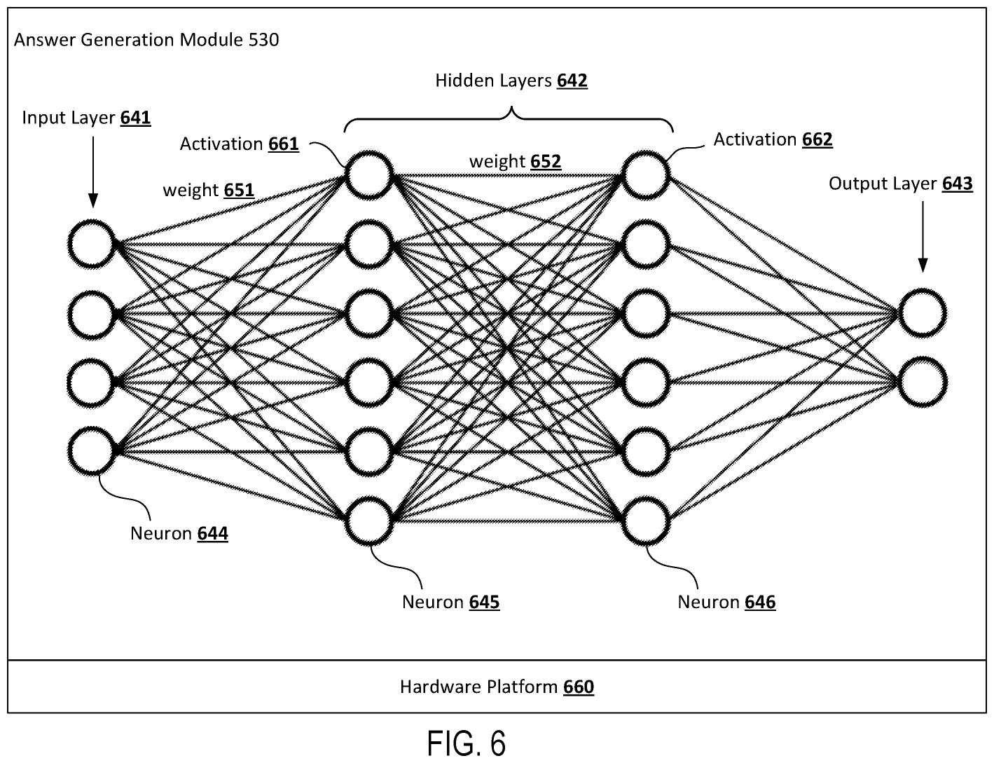

FIG. 6 is a simplified diagram illustrating the neural network structure implementing the answer generation module 530 described in FIG. 5, according to some embodiments. In some embodiments, the answer generation module 630 and/or one or more of its submodules 631-132 may be implemented at least partially via an artificial neural network structure shown in FIG. 6B. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 643. Each layer may comprise a plurality of neurons, and neurons between layers are interconnected according to a specific topology of the neural network topology. The input layer 641 receives the input data (e.g., 640 in FIG. 6A), such as a text question. The number of nodes (neurons) in the input layer 641 may be determined by the dimensionality of the input data (e.g., the length of a vector of a text question). Each node in the input layer represents a feature or attribute of the input.

The hidden layers 642 are intermediate layers between the input and output layers of a neural network. It is noted that two hidden layers 642 are shown in FIG. 6B for illustrative purpose only, and any number of hidden layers may be utilized in a neural network structure. Hidden layers 642 may extract and transform the input data through a series of weighted computations and activation functions.

For example, as discussed in FIG. 5, the answer generation module 530 receives an input 640 of a question and transforms the input into an output 650 of an answer. To perform the transformation, each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the answer generation module 630 and/or one or more of its submodules 631-632 may comprise the transformative neural network structure of layers of neurons, and weights and activation functions describing the non-linear transformation at each neuron. Such a neural network structure is often implemented on one or more hardware processors 610, such as a graphics processing unit (GPU). An example neural network may be a Transformer network, and/or the like.

In one embodiment, the answer generation module 630 and its submodules 631 may be implemented by hardware, software and/or a combination thereof. For example, the answer generation module 630 and its submodules 631-132 may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

In one embodiment, the neural network based answer generation module 630 and one or more of its submodules 631-132 may be trained by iteratively updating the underlying parameters (e.g., weights 651, 652, etc., bias parameters and/or coefficients in the activation functions 661, 662 associated with neurons) of the neural network based on the loss. For example, during forward propagation, the training data such as a question are fed into the neural network. The data flows through the network's layers 641, 642, with each layer performing computations based on its weights, biases, and activation functions until the output layer 643 produces the network's output 650. In some embodiments, output layer 643 produces an intermediate output on which the network's output 650 is based.

The output generated by the output layer 643 is compared to the expected output (e.g., a “ground-truth” such as the corresponding answer) from the training data, to compute a loss function that measures the discrepancy between the predicted output and the expected output. For example, the loss function may be a cross entropy, MMSE, and/or the like. Given the loss, the negative gradient of the loss function is computed with respect to each weight of each layer individually. Such negative gradient is computed one layer at a time, iteratively backward from the last layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

Parameters of the neural network are updated backwardly from the last layer to the input layer (backpropagating) based on the computed negative gradient using an optimization algorithm to minimize the loss. The backpropagation from the last layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as question answering.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in automatic answering agent applications.

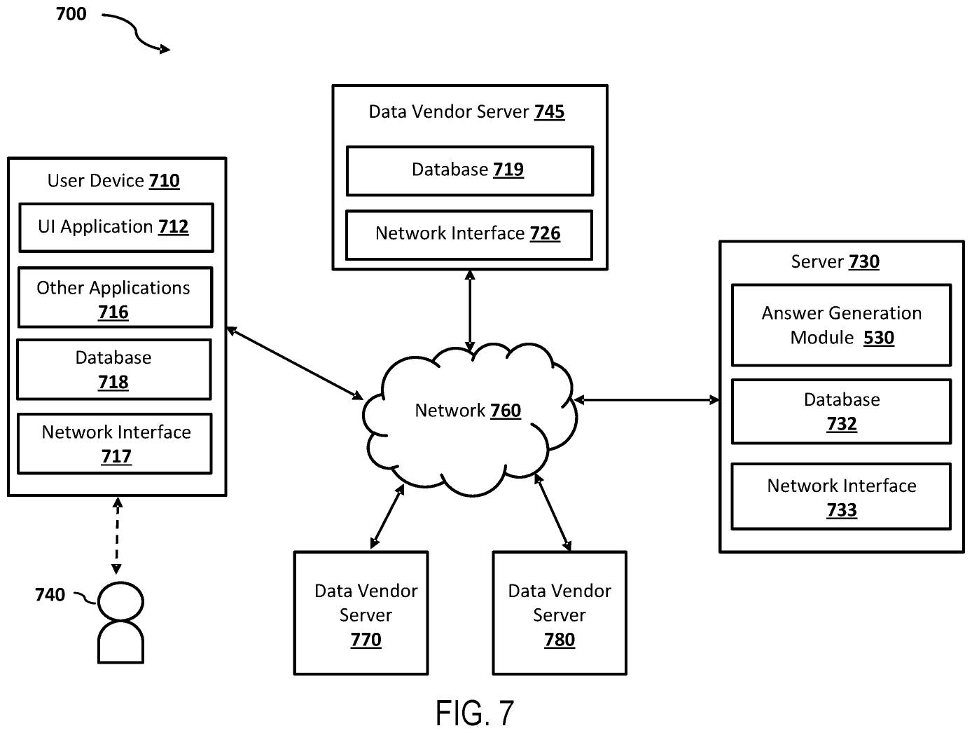

FIG. 7 is a simplified block diagram of a networked system suitable for implementing the answer generation framework described in FIG. 5 and other embodiments described herein. In one embodiment, system 700 includes the user device 710 which may be operated by user 740, data vendor servers 745, 770 and 780, server 730, and other forms of devices, servers, and/or software components that operate to perform various methodologies in accordance with the described embodiments. Exemplary devices and servers may include device, stand-alone, and enterprise-class servers which may be similar to the computing device 500 described in FIG. 5, operating an OS such as a MICROSOFT® OS, a UNIX® OS, a LINUX® OS, or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 710, data vendor servers 745, 770 and 780, and the server 730 may communicate with each other over a network 760. User device 710 may be utilized by a user 740 (e.g., a driver, a system admin, etc.) to access the various features available for user device 710, which may include processes and/or applications associated with the server 730 to receive an output data anomaly report.

User device 710, data vendor server 745, and the server 730 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760.

User device 710 may be implemented as a communication device that may utilize appropriate hardware and software configured for wired and/or wireless communication with data vendor server 745 and/or the server 730. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and/or other applications 716, which may correspond to executable processes, procedures, and/or applications with associated hardware. For example, the user device 710 may receive a message indicating a generated answer from the server 730 and display the message via the UI application 712. In other embodiments, user device 710 may include additional or different modules having specialized hardware and/or software as required.

In various embodiments, user device 710 includes other applications 716 as may be desired in particular embodiments to provide features to user device 710. For example, other applications 716 may include security applications for implementing client-side security features, programmatic client applications for interfacing with appropriate application programming interfaces (APIs) over network 760, or other types of applications. Other applications 716 may also include communication applications, such as email, texting, voice, social networking, and IM applications that allow a user to send and receive emails, calls, texts, and other notifications through network 760. For example, the other application 716 may be an email or instant messaging application that receives a prediction result message from the server 730. Other applications 716 may include device interfaces and other display modules that may receive input and/or output information. For example, other applications 716 may contain software programs for asset management, executable by a processor, including a graphical user interface (GUI) configured to provide an interface to the user 740 to view the answer.

User device 710 may further include database 718 stored in a transitory and/or non-transitory memory of user device 710, which may store various applications and data and be utilized during execution of various modules of user device 710. Database 718 may store user profile relating to the user 740, predictions previously viewed or saved by the user 740, historical data received from the server 730, and/or the like. In some embodiments, database 718 may be local to user device 710. However, in other embodiments, database 718 may be external to user device 710 and accessible by user device 710, including cloud storage systems and/or databases that are accessible over network 760.

User device 710 includes at least one network interface component 717 adapted to communicate with data vendor server 745 and/or the server 730. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 745 may correspond to a server that hosts database 719 to provide training datasets including question-answer pairs to the server 730. The database 719 may be implemented by one or more relational database, distributed databases, cloud databases, and/or the like.

The data vendor server 745 includes at least one network interface component 726 adapted to communicate with user device 710 and/or the server 730. In various embodiments, network interface component 726 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 745 may send asset information from the database 719, via the network interface 726, to the server 730.

The server 730 may be housed with the answer generation module 530 and its submodules described in FIG. 5. In some implementations, answer generation module 530 may receive data from database 719 at the data vendor server 745 via the network 760 to generate an answer. The generated answer may also be sent to the user device 710 for review by the user 740 via the network 760.

The database 732 may be stored in a transitory and/or non-transitory memory of the server 730. In one implementation, the database 732 may store data obtained from the data vendor server 745. In one implementation, the database 732 may store parameters of the answer generation module 130. In one implementation, the database 732 may store previously generated answer, and the corresponding input feature vectors.

In some embodiments, database 732 may be local to the server 730. However, in other embodiments, database 732 may be external to the server 730 and accessible by the server 730, including cloud storage systems and/or databases that are accessible over network 760.

The server 730 includes at least one network interface component 733 adapted to communicate with user device 710 and/or data vendor servers 745, 770 or 780 over network 760. In various embodiments, network interface component 733 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

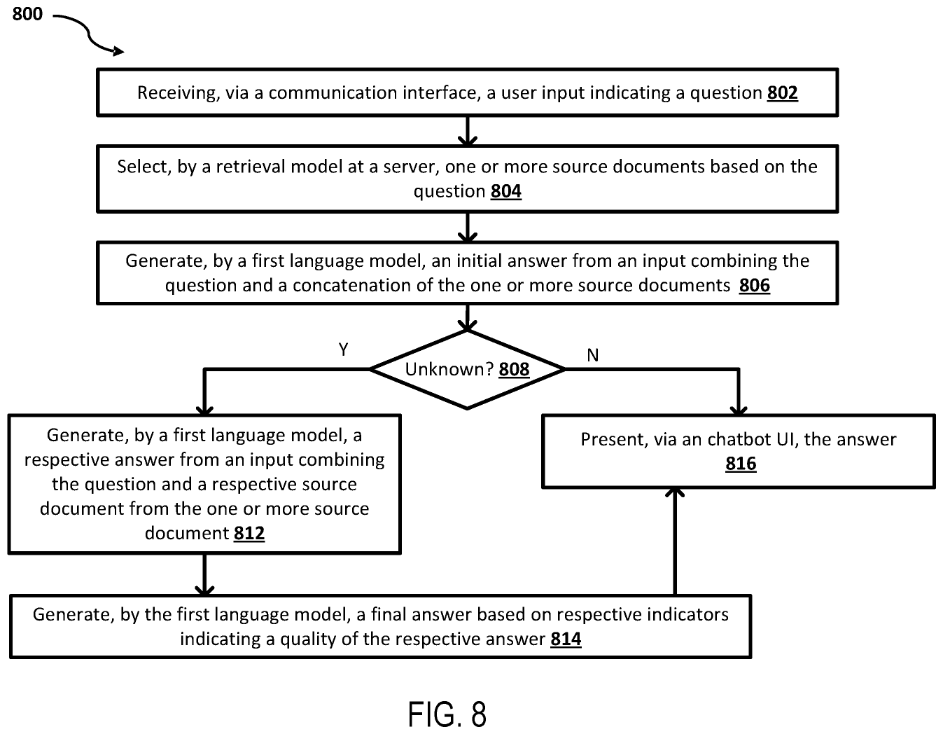

FIG. 8 is an example logic flow diagram illustrating a method of generating an answer to an input question using one or more neural network models based on the framework shown in FIGS. 1-7, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the answer generation network module 530 (e.g., FIGS. 5 and 7).

As illustrated, the method 800 includes a number of enumerated steps, but aspects of the method 800 may include additional steps before, after, and in between the enumerated steps. In some aspects, one or more of the enumerated steps may be omitted or performed in a different order.

At step 802, a user input indicating a question (e.g., 102 in FIGS. 1A-1C) may be received via a communication interface (e.g., 515 in FIG. 5).

At step 804, a retrieval model (e.g., 110 in FIG. 1A) at a server may select one or more source documents (e.g., 112a-n in FIGS. 1A-1C) based on the question.

At step 806, a first language model (e.g., LLM 120 in FIGS. 1A-1C) may generate an answer from an input combining the question and a respective source document from the one or more source document. In one implementation, the answer is generated by the first language model further based on a prompt that guides the first language model to generate a negative answer when the first language model determines that the respective source document contains insufficient information to answer the question.

In another implementation, the answer is generated by the first language model further based on a prompt that contains a demonstration differentiating irrelevant source documents from relevant source documents that contain sufficient information to answer the question.

In another implementation, the respective answer is generated by the first language model further based on a prompt that contains a demonstration generating a summary of the respective source document, based on which an answer is generated.

At step 808, if the generated answer is “unknown” indicating the LLM may determine the source documents are insufficient to answer the question, method 800 may proceed to step 812, at which the first language model may generate a respective answer from an input combining the question and a respective source document from the one or more source document. The respective answers may form an answer pool (e.g., 122 in FIG. 3).

At step 814, the first language model may then generate a final answer based on respective indicators indicating a quality of the respective answer, e.g., based on the highest indicator. The respective indicator is generated by a second language model based on an input combining the respective answer and the question.

At step 816, the final answer may be presented via a UI, e.g., a chatbot UI.

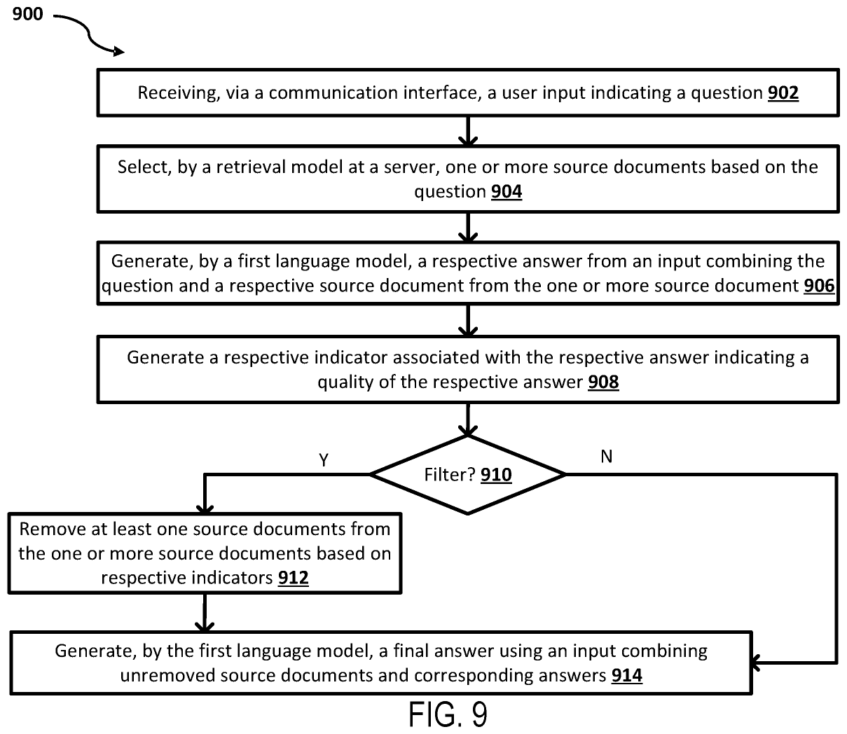

FIG. 9 is an example logic flow diagram illustrating a method of generating an answer to an input question using one or more neural network models based on the framework shown in FIGS. 1-7, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 900 corresponds to the operation of the answer generation network module 530 (e.g., FIGS. 5 and 7).

As illustrated, the method 900 includes a number of enumerated steps, but aspects of the method 900 may include additional steps before, after, and in between the enumerated steps. In some aspects, one or more of the enumerated steps may be omitted or performed in a different order.

Steps 902-904 may be similar to steps 802-804 of method 800. At step 906, the first language model may generate a respective answer from an input combining the question and a respective source document from the one or more source document.

At step 908, a respective indicator may be generated associated with the respective answer indicating a quality of the respective answer.

At step 901, method 900 may determine whether to filter an “unknown” answer in the generated answers. If yes, method proceeds to step 912, at which, the corresponding source documents may be removed from the one or more source documents based on respective indicators that indicate the respective answer is “unknown” (e.g., 125n in FIG. 4).

At step 914, the first language model may generate a final answer (e.g., 138 in FIG. 4) using an input combining unremoved source documents (e.g., 112a-b in FIG. 4) and corresponding answers.

### Example Results

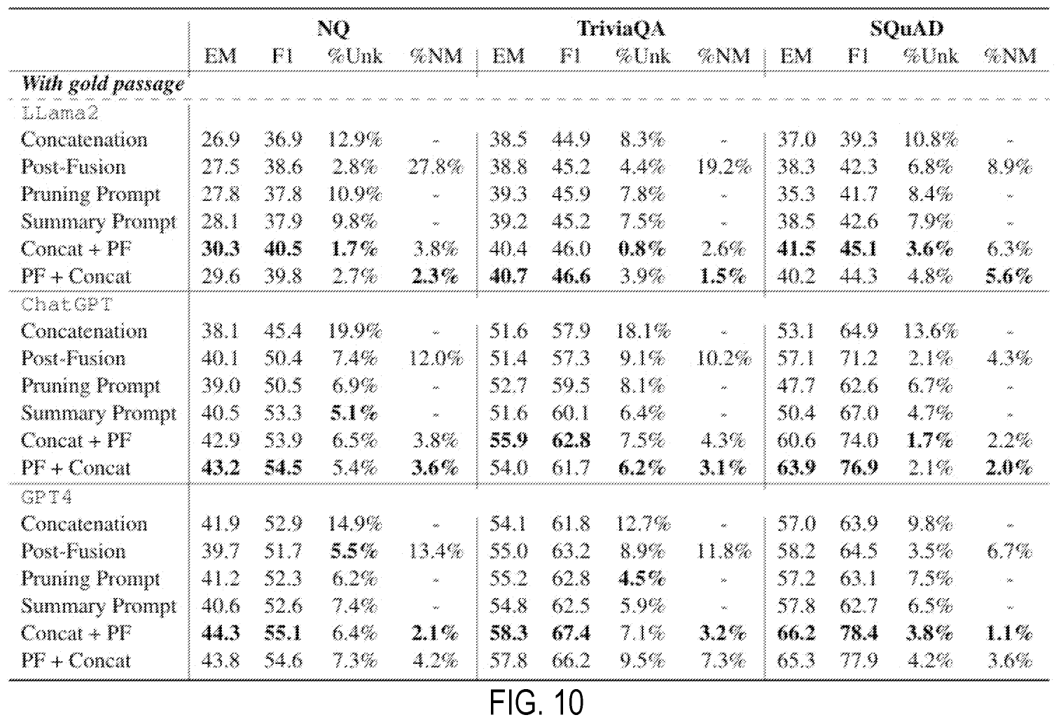

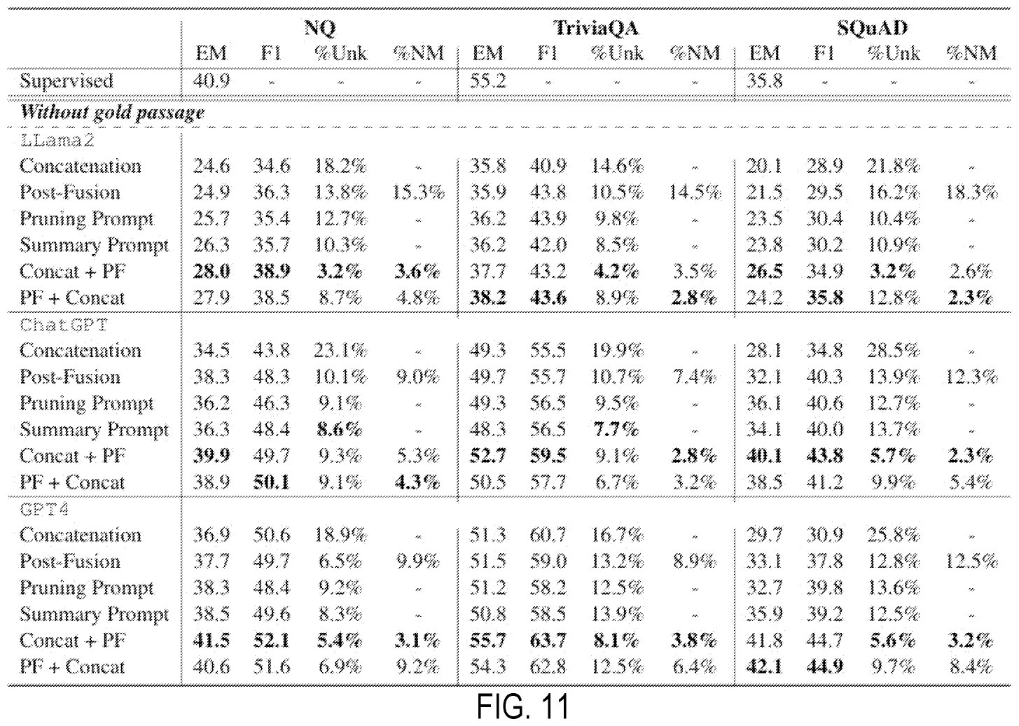

FIGS. 10-11 provide example results of data experiments comparing generation frameworks described in FIGS. 1A-1C and FIGS. 3-4 with various baselines. Example datasets used include Natural Questions (NQ) (described in Kwiatkowski et al., Natural questions: a benchmark for question answering research. Transactions of the Association for Computational Linguistics, 7:453-466, 2019), TriviaQA (Trivedi et al., Multi-hop questions via single-hop question composition. Transactions of the Association for Computational Linguistics, 10:539-554, 2022), and SQUAD-Open (Ho et al., Constructing a multi-hop qa dataset for comprehensive evaluation of reasoning steps. In Proceedings of the 28th International Conference on Computational Linguistics, 6609-6625, 2020) are all datasets designed for training and evaluating single-hop question answering models. NQ is sourced from Google Search queries and their corresponding Wikipedia answers. TriviaQA offers a broader domain with trivia questions and their answers derived from web and Wikipedia sources. Conversely, SQUAD-Open is a variant of the original SQUAD dataset that requires the model to extract answers from open-domain Wikipedia content, without any pre-specified passage.

Example evaluation metrics include QA dataset evaluation methods (described in Yang et al., Hotpotqa: A dataset for diverse, explainable multi-hop question answering, in Proceedings of the 2018 Conference on Empirical Methods in Natural Language Processing, 2369-2380; Ho et al., 2020), contrasting with the recent LLM evaluations on QA tasks detailed in Liu et al., Lost in the middle: How lan-guage models use Jong contexts. arXiv preprint arXiv:2307.03172, 2023), which assess whether the generated answer includes the ground truth. Importantly, our evaluation criteria are more rigorous than these recent LLM evaluations (Liu et al., 2023), given that we mandate the LLM to adhere strictly to the given prompt in generating an entity-specific answer. In detail, predicted answers are evaluated with the standard answer exact match (EM) and Fl metric (Rajpurkar et al., Squad: 100,000+ questions for machine comprehension of text, in Proceedings of the 2016 Conference on Empirical Methods in Natural Language Processing, 2383-2392, 2016; Liu et al., Uni-parser: Unified semantic parser for question answering on knowledge base and database. In Proceedings of the 2022 Conference on Empirical Methods in Natural Language Processing, 8858-8869, 2022). A generated response is considered correct if, after normalization, it matches any candidate in a list of acceptable answers. The normalization process entails converting the text to lowercase and omitting articles, punctuation, and redundant whitespaces.

The percentage of “unknown” responses (% Unk) which gauges the proportion of times the LLM indicates it cannot answer based on the given input is also evaluated. Additionally, the error rate through majority vote (% NM) is measured, representing instances where the correct answer is within the generated answer list but is not the majority selection.

To mitigate the influence of specific training datasets on the LLM (Aiyappa et al., Can we trust the evaluation on chatgpt? arXiv preprint arXiv: 2303. 12767, 2023), the LLM may be prompted to answer questions without any provided context, which filters out questions that the LLM can accurately answer independently, thereby eliminating the need for additional external contextual infor-mation. The remaining questions, which the LLM could not answer independently, are the focus of our study. This filtering ensures our evaluation stringently reflects the LLM's ability to utilize external context from retrieved passages.

The development set of NQ TriviaQA, and SQUAD, initially constructed 5,892, 6,760, 5,928 questions, respectively. After removing questions that can be answered without context, 3,459 questions in NQ, 1,259 in TriviaQA, and 3,448 in SQUAD remain. The data experiments use Wikipedia dump from Dec. 20, 2018 for NQ and TriviaQA and the dump from Dec. 21, 2016 for SQUAD. Two different settings for this study. The first utilizes the top-k retrieved passages directly (gold passage is not necessarily included).

In contrast, the second setting concerns the situation that the gold-standard passage is included in the context. If the gold passage is not within the top-k passages, we randomly insert it into the top-k list. Both open and close LLMs for Llama2 version, Llama-2-7b-chat-hf model and apply greedy decoding with the temperature parameter set to 0. For LLM 120, the gpt-3. 5-turbo-16 k model. For GPT4 (OpenAI, 2023) may be used.

The results using the gold passages setting are presented in FIG. 10, while those without incorporating gold passages are in FIG. 11. Initially, the Top-5 retrieved passages, representing the set-ting without added gold passages. If these passages don't contain the answer, the gold passage is randomly integrated among the Top-5 candidate passages, corresponding to the setting with gold passages.

FIG. 10 shows that among the single-round zero-shot methods, Post-Fusion (e.g., 100b in FIG. 1B) consistently surpasses concatenation approach (e.g., 100a in FIG. 1A) in both EM and Fl metrics across all three benchmarks. This indicates that the model may become distracted when faced with a combination of relevant passages. Compared to zero-shot and few-shot approaches, both Pruning Prompt (e.g., FIG. 2B) and Summary Prompt (e.g., FIG. 2C) show a marked enhancement over the concatenation method, though the margin of improvement is modest. The use of the CoT, which elicits a potential reasoning process, can guide the model in attending to relevant passages. However, this approach does not greatly enhance single-hop question answering as compared to prior multi-hop reasoning studies.

Compared to single-round methods shown in FIGS. 1A-1B, multi-round strategies (e.g., shown in FIGS. 3-4) consistently deliver superior performance, showcasing significant improvements. For instance, on the NQ dataset, Concat+PF exceeds the Concatenation method by over 10% on average across three distinct LLMs. It suggests the efficacy of integrating model uncertainty as feedback. Among the multi-round approaches, Concat+PF demonstrates better performance compared to PF+Concat on most of cases. Comparing PF+Concat with Post-Fusion, it is evident that PF+Concat, leveraging LLM to select the best answer from approach.

In the realm of open-domain question-answering, as evidenced by FIG. 11, the performance metrics (EM and Fl) under settings without the addition of a gold passage are comparatively lower. This is primarily attributed to the reduced recall of Top-k retrieval, resulting in a higher propensity to generate “unknown” responses. Notably, the proposed multi-round methodologies shown in FIGS. 3-4 and 8-9, when leveraging GPT4 as the LLM, deliver performance figures that are on par with supervised outcomes candidate pool, outperforms the majority vote approach.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for generating an answer to an input question using one or more neural network models, comprising:
receiving, via a user interface, a user input indicating a question;
selecting, by a retrieval model at a server, one or more source documents based on the question;
generating, by a first language model, a respective answer from an input combining the question and a respective source document from the one or more source document;
generating a respective indicator associated with the respective answer indicating a quality of the respective answer; and
generating, via the user interface, a response to the user input by selecting an answer from generated answers based on respective indicators.

2. The method of claim 1, wherein the respective indicator is generated by a second language model based on an input combining the respective answer and the question.

3. The method of claim 1, wherein the respective answer is generated by the first language model further based on a prompt that guides the first language model to generate a negative answer when the first language model determines that the respective source document contains insufficient information to answer the question.

4. The method of claim 1, wherein the respective answer is generated by the first language model further based on a prompt that contains a demonstration differentiating irrelevant source documents from relevant source documents that contain sufficient information to answer the question.

5. The method of claim 1, wherein the respective answer is generated by the first language model further based on a prompt that contains a demonstration generating a summary of the respective source document, based on which an answer is generated.

6. The method of claim 1, further comprising:
generating, by the first language model, an initial answer from an input combining the question and a concatenation of the one or more source documents prior to generating respective answers based on respective source documents independently; and
generating, by the first language model, the respective answer when the initial answer indicates the concatenation of the one or more source documents contain insufficient information to answer the question.

7. The method of claim 1, further comprising:
removing at least one source documents from the one or more source documents based on respective indicators.

8. The method of claim 7, further comprising:
generating, by the first language model, a final answer using an input combining unremoved source documents and corresponding answers.

9. A system for generating an answer to an input question using one or more neural network models, the system comprising:
a communication interface configured to receive, via a user interface, a user input indicating a question;
a memory storing a plurality of processor-executable instructions; and
one or more processors executing the instructions to perform operations comprising:
selecting, by a retrieval model at a server, one or more source documents based on the question;
generating, by a first language model, a respective answer from an input combining the question and a respective source document from the one or more source document;
generating a respective indicator associated with the respective answer indicating a quality of the respective answer; and
generating, via the user interface, a response to the user input by selecting an answer from generated answers based on respective indicators.

10. The system of claim 9, wherein the respective indicator is generated by a second language model based on an input combining the respective answer and the question.

11. The system of claim 9, wherein the respective answer is generated by the first language model further based on a prompt that guides the first language model to generate a negative answer when the first language model determines that the respective source document contains insufficient information to answer the question.

12. The system of claim 9, wherein the respective answer is generated by the first language model further based on a prompt that contains a demonstration differentiating irrelevant source documents from relevant source documents that contain sufficient information to answer the question.

13. The system of claim 9, wherein the respective answer is generated by the first language model further based on a prompt that contains a demonstration generating a summary of the respective source document, based on which an answer is generated.

14. The system of claim 9, wherein the operations further comprise:
generating, by the first language model, an initial answer from an input combining the question and a concatenation of the one or more source documents prior to generating respective answers based on respective source documents independently; and
generating, by the first language model, the respective answer when the initial answer indicates the concatenation of the one or more source documents contain insufficient information to answer the question.

15. The system of claim 9, wherein the operations further comprise:
removing at least one source documents from the one or more source documents based on respective indicators.

16. The system of claim 15, wherein the operations further comprise:
generating, by the first language model, a final answer using an input combining unremoved source documents and corresponding answers.

17. A non-transitory processor-readable medium storing a plurality of processor-executable instructions for generating an answer to an input question using one or more neural network models, the instructions being executed by one or more processors to perform operations comprising:
receiving, via a user interface, a user input indicating a question;
selecting, by a retrieval model at a server, one or more source documents based on the question;
generating, by a first language model, a respective answer from an input combining the question and a respective source document from the one or more source document;
generating a respective indicator associated with the respective answer indicating a quality of the respective answer; and
generating, via the user interface, a response to the user input by selecting an answer from generated answers based on respective indicators.

18. The medium of claim 17, wherein the respective answer is generated by the first language model further based on a prompt that guides the first language model to generate a negative answer when the first language model determines that the respective source document contains insufficient information to answer the question.

19. The medium of claim 17, wherein the respective answer is generated by the first language model further based on a prompt that contains a demonstration differentiating irrelevant source documents from relevant source documents that contain sufficient information to answer the question.

20. The medium of claim 17, wherein the respective answer is generated by the first language model further based on a prompt that contains a demonstration generating a summary of the respective source document, based on which an answer is generated.
